(19) United States
(12) Patent Application Publication
(10) Pub. No.: US 2020/0288726 A1
(43) Pub. Date: Sep. 17, 2020

(54) GLUTEN-FREE BREAD PRODUCTS

(71) Applicant: Shandong Jianyuan Bioengineering Co., Ltd, Shandong (CN)

(72) Inventor: Xue Yuan WANG, Zhaoyuan City (CN)

(21) Appl. No.: 16/340,023

(22) PCT Filed: Oct. 6, 2017
(86) PCT No.: PCT/IB2017/056165

§ 371 Date: May 26, 2020

(30) Foreign Application Priority Data
Oct. 6, 2016 (AU) 2016904062

(51) Int. Cl. A21D 13/066; A23L 33/115; A23L 33/185; A23L 33/24; A23L 33/00; A23L 29/269; A23L 29/212

(52) U.S. Cl. CPC A21D 13/066; A23L 33/115; A23L 33/185; A23L 29/212; A23L 33/30; A23L 29/269; A23L 33/24

(57) ABSTRACT

Provided herein are compositions for producing gluten-free bread products, comprising pea starch and at least about 0.5% by weight pea protein based on the total weight of the composition. Also provided are gluten-free bread and bread products, and processes for preparing the same, wherein the bread and bread products comprise pea protein and pea starch, wherein the pea protein is present at at least about 0.5% by weight pea protein based on the total weight of the product.

### FIELD OF THE ART

The present disclosure relates generally to gluten-free bread and bread products, and processes for preparing the same, wherein the bread and bread products comprise pea protein and pea starch.

### BACKGROUND

Gluten refers to a combination of proteins found combined with starch in the endosperm of most cereals. Gluten is found in most cereals (e.g., wheat, rye, oats, barley and related grains such as triticale and spelt) and is commonly found in all foods that contain these grains. It constitutes more than 80% of the proteins contained in wheat. Gluten is comprised of two main groups of proteins, gliadins and glutenins. Gluten is responsible for the elasticity of kneaded dough which allows it to be leavened, and is responsible for the sponge structure and the soft elastic texture of breads and bread products.

However the ingestion of gluten-containing products can cause digestive problems. Specifically, the degradation of the gluten protein complex in the digestive tract can trigger an immune response, commonly referred to a celiac disease. A significant, and growing, proportion of the population suffers from celiac disease. It is estimated that approximately 1 in 100 people worldwide suffers from celiac disease.

Celiac disease is a digestive, autoimmune disorder characterized by inflammation and cryptic hyperplasia in the intestine. The mucosa of the proximal small intestine is damaged by an immune response to gluten peptides that are resistant to digestive enzymes. This damage interferes with the body's ability to absorb vital nutrients such as proteins, carbohydrates, fat, vitamins, minerals, and in some cases, even water and bile salts, leading to common manifestations of the disorder such as chronic diarrhoea, abdominal distension and a failure to thrive. If untreated, celiac disease can increase the risk of other disorders, such as anemia, osteoporosis, infertility and neurological problems, and has been associated with increased rates of cancer and other autoimmune disorders.

In addition to sufferers of celiac disease, other individuals may also be gluten-intolerant or gluten sensitive, including individuals with Crohn's disease, ulcerative colitis or irritable bowel syndrome.

Adherence to a gluten-free diet is the only known, effective treatment for celiac disease and to combat gluten sensitivity or intolerance. Accordingly, there is an increasing need for food products that are gluten-free.

Much effort over the past several years has gone into developing gluten-free food products such as breads. However most commercial gluten-free bread has poor structure or texture when compared with bread produced using wheat flour. There is therefore a need for improved gluten-free bread products.

### SUMMARY OF THE DISCLOSURE

Embodiments of the present disclosure are directed to compositions for making gluten-free bread products, and gluten-free bread products made using these compositions. Also provided are premixes that can be used to make gluten-free bread products, and processes for making gluten-free bread products.

More specifically, the present disclosure provides compositions and premixes for producing a gluten-free bread product, comprising pea protein and pea starch.

In a first aspect, the present disclosure provides a composition for producing gluten-free bread products, comprising pea starch and at least about 0.5% by weight pea protein based on the total weight of the composition.

The pea protein may comprise one or more of a pea protein isolate, pea protein hydrolysates and coagulated pea protein.

The composition may comprise between about 1% and 5% by weight pea protein. In an exemplary embodiment, the composition comprises about 3.5% by weight pea protein based on the total weight of the composition.

The composition may comprise at least about 5% by weight pea starch based on the total weight of the composition. The composition may comprise between about 10% and 90% by weight pea starch based on the total weight of the composition. Typically the pea starch is raw (uncooked) starch. In an exemplary embodiment, the composition comprises about 75% by weight raw pea starch based on the total weight of the composition.

The composition typically comprises one or more additional ingredients for making the bread product, including, for example, water, yeast and a gluten-free flour. In one exemplary embodiment, the composition comprises pea protein (at least 0.5% by weight based on the total weight of the composition), pea starch, rice flour, yeast, xanthan gum and water. In a further exemplary embodiment the composition comprises pea protein (at least 0.5% by weight based on the total weight of the composition), pea starch, yeast, and xanthan gum. The exemplary compositions may optionally further comprise vegetable oil, sugar, salt and/or hydroxypropylmethycellulose (HPMC).

The composition may be in the form of a wet or dry mixture or premix for producing the bread product. The composition may be used to produce a dough. Thus, a second aspect of the present disclosure provides a dough comprising a composition of the first aspect. The bread product may comprise leavened or unleavened bread.

A third aspect of the present disclosure provides a gluten-free bread product produced with a composition of the first aspect or a dough of the second aspect.

### BRIEF DESCRIPTION OF THE DRAWINGS

Embodiments of the disclosure are described herein, by way of non-limiting example only, with reference to the following figures:

FIG. 1. Flowchart of extraction of pea protein from yellow peas in accordance with an exemplary embodiment of the present disclosure.

FIG. 2. Flowchart of extraction of pea starch from yellow peas in accordance with an exemplary embodiment of the present disclosure.

FIG. 3: Appearance of gluten-free breads produced from two recipes in accordance with embodiments of the present disclosure.

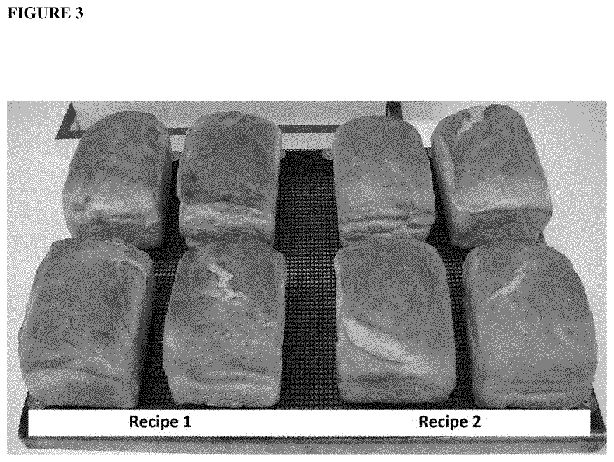

FIG. 4: Cross-section of breads of FIG. 1.

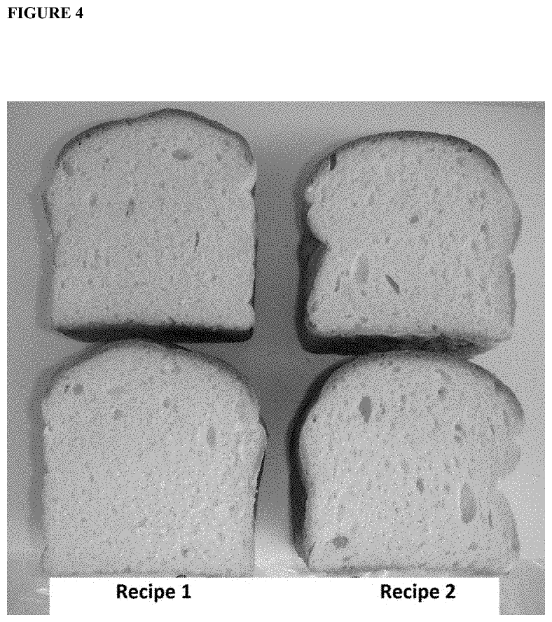

### DETAILED DESCRIPTION

Unless defined otherwise, all technical terms used herein have the same meaning as commonly understood by those of ordinary skill in the art to which the disclosure belongs. Although any methods and materials similar or equivalent to those described herein can be used in the practice or testing of the present disclosure, typical methods and materials are described.

In the context of this specification, the terms “a” and “an” are used herein to refer to one or to more than one (i.e. to at least one) of the grammatical object of the article. By way of example, “an element” means one element or more than one element.

In the context of this specification, the term “about,” is understood to refer to a range of numbers that a person of skill in the art would consider equivalent to the recited value in the context of achieving the same function or result.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

The term “optionally” is used herein to mean that the subsequently described feature may or may not be present or that the subsequently described event or circumstance may or may not occur. Hence the specification will be understood to include and encompass embodiments in which the feature is present and embodiments in which the feature is not present, and embodiments in which the event or circumstance occurs as well as embodiments in which it does not.

Provided herein are compositions for use in the production of breads and bread products that are gluten-free. In accordance with the present disclosure, the compositions comprise at least about 0.5% by weight pea protein, and pea starch. Also provided herein are doughs formed from compositions described herein, and bread products produced using compositions and doughs of the present disclosure. Bread products of the present disclosure possess a structure and texture comparable to gluten-containing bread made with wheat flour. Bread products of the present disclosure can also be GMO free, when made utilizing non-GMO peas as the source of pea protein and pea starch.

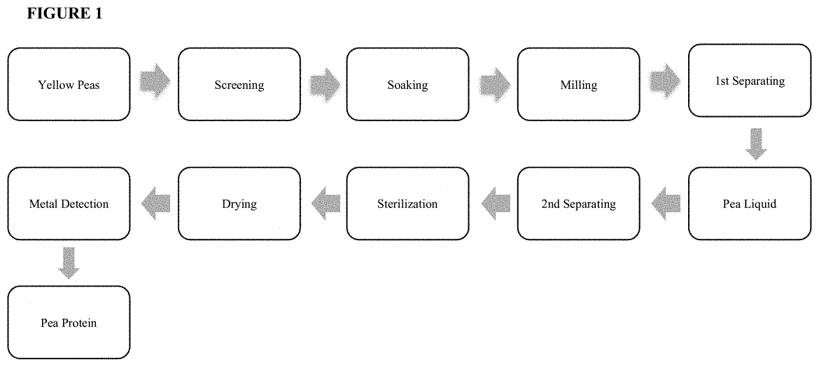

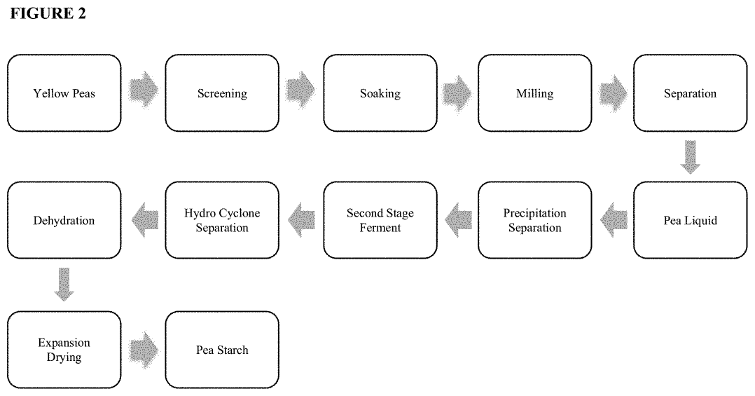

By “pea protein” and “pea starch”, the skilled addressee will understand that the protein or starch is derived or isolated from peas, namely Pisum spp., such as Pisum sativum. Suitable pea varieties include green pea, yellow pea, chick pea, black eyed pea and the like. In particular embodiments, the pea is a yellow pea. Exemplary processes for the extraction of pea protein and pea starch from yellow peas are shown in FIGS. 1 and 2, respectively. In both processes, peas are wet milled into a liquid after which material is separated by centrifugation to separate pea fiber from a combined mixture comprising pea protein and pea starch.. The pea protein and pea starch are separated by a process involving decanting. The pea starch material undergoes second stage fermentation followed by hydro cyclone separation and subsequent isolation of starch using a vacuum drum and drying into a powder.

Proteins found in peas are typically comprised of three classes of proteins: globulins, albumins and insoluble proteins. In a typical pea protein composition, the soluble proteins of the pea, i.e. the globulins (legumins, vicilins and concivilins) and albumins (predominantly the albumins PA1 and PA2) comprise about 85% of the total proteins. For the purpose of the present specification, the term “pea protein” when used in the context of its inclusion in a composition for producing gluten-free bread products, may refer to any one or more of these individual, or groups of, proteins found in peas, more typically to a “pea protein” composition. Typically the “pea protein” used is a pea protein combination or composition, in the form of a pea protein isolate, pea protein lysate, pea protein hydrolysate, pea protein concentrate or coagulated pea protein composition. The terms “pea protein”, “pea protein composition” and “pea protein combination” may be used interchangeably herein. In an exemplary embodiment, the pea protein is extracted or derived from yellow peas.

The amount of pea protein in a composition according to the present disclosure is typically at least about 0.5% by weight based on the total weight based of the composition. The amount may be, for example, about 0.5% by weight, about 1% by weight, about 1.5% by weight, about 2% by weight, about 2.5% by weight, about 3% by weight, about 3.5% by weight, about 4% by weight, about 4.5% by weight, or about 5% by weight based on the total weight based of the composition. In exemplary embodiments, the amount of pea protein may be about 3.5% by weight based on the total weight of the composition.

Typically pea starch is used in accordance with embodiments of the present disclosure in order to is used in order to replace wheat flour and other commonly used flours or starches (such as corn flour or starch, potato flour or starch, millet flour or starch, tapioca flour or starch etc. In an exemplary embodiment, the pea starch is extracted or derived from yellow peas. Typically the pea starch used for the preparation of bread and bread products in accordance with the present disclosure is raw (uncooked) pea starch.

The amount of pea starch in a composition according to the present disclosure is typically at least about 5% by weight based on the total weight based of the composition. The amount may be, for example, about 5% by weight, about 10% by weight, about 15% by weight, about 20% by weight, about 25% by weight, about 30% by weight, about 35% by weight, about 40% by weight, about 45% by weight, about 50% by weight, about 55% by weight, about 60% by weight, about 65% by weight, about 70% by weight, about 75% by weight, about 80% by weight, about 85% by weight, or about 90% by weight based on the total weight based of the composition. In exemplary embodiments, the amount of pea starch may be about 3.5% by weight based on the total weight of the composition.

The ratio of pea protein to pea starch may be between about 1:10 and 1:90. The ratio of pea protein to pea starch may be about 1:10, 1:15, 1:20, 1:25, 1:30, 1:35, 1:40, 1:45, 1:50, 1:55, 1:60, 1:65, 1:70, 1:75, 1:80, 1:85 or 1:90. Exemplary ratios of pea protein to pea starch are: 1:12 (for example optionally 5% by weight pea protein and 60% raw pea starch, based on the total weight of the composition); 1:18 (for example optionally 5% by weight pea protein and 90% raw pea starch, based on the total weight of the composition); 1:20 (for example optionally 3% by weight pea protein and 60% raw pea starch, based on the total weight of the composition); 1:21 (for example optionally 3.5% by weight pea protein and 75% raw pea starch, based on the total weight of the composition); and 1:30 (for example optionally 3% by weight pea protein and 90% raw pea starch, based on the total weight of the composition).

Compositions according to the present disclosure typically also comprise one or more additional ingredients for making the bread product, including, for example, water, yeast and a gluten-free flour. A person skilled in the art can readily determine, without undue burden, the amounts of each component of the composition suitable for use in producing bread products. The suitable amounts of each additional component will depend upon a variety of factors including the nature of the bread product to be produced and the desired characteristics of the bread product such as texture, consistency, mouth feel, taste and shelf life.

For example, the amount of water present in the composition, or to be added to a dry mixture composition for making the bread product will vary depending on, for example, the type of bread product to be produced. Water content may be between, for example, about 5% and about 50% by weight, such as about 5% by weight, about 10% by weight, about 15% by weight, about 20% by weight, about 25% by weight, about 30% by eight, about 35% by weight, about 40% by weight, about 45% by weight and about 50% by weight.

Gluten-free flour refers to a powder or powder-like substance made of cereal grains, other seeds, or roots that are essentially free of gluten protein. The gluten-free flours used herein can be naturally gluten free or processed to eliminate gluten content. An exemplary gluten-free flour is rice flour. Any yeast suitable for bread making can be used. A typical example is Saccharomyces cerevisiae. A person skilled in the art can readily determine the amounts of each component of the composition suitable for use in producing bread products.

The compositions may further comprise one or more additional food grade components, such as, for example, fats, oils such as vegetable oils, hydrocolloids, carbohydrates, fibre, minerals, salt, sugar, acid, vitamins, antioxidants, flavonoids, colorants, flavoring compounds, thickeners, stabilizers, emulsifiers, or preservatives. An exemplary thickener is xanthan gum. An exemplary emulsifier and/or stabilizer is guar gum.

In the present specification, the term “bread product” refers to a food product prepared by fermenting a dough prepared from a composition as described herein. Additional ingredients such as dairy products, eggs, fruits and vegetables can be incorporated into compositions, doughs or resultant bread products. Bread products include leavened and unleavened breads, such as loaf breads and pita breads, and any other food product made by a process involving baking a bread dough. Exemplary breads and bread products include, but are not limited to, loaf bread, pita bread, Italian bread, French bread, bread rolls, focaccia, sourdough bread, baguette, boule, batard, breadstick, croutons, hot dog buns, pizza base, man, bagel, brezel, horn, Danish, croissant, walnut bread, brioche, pain aux raisin, savarin, stollen, panettone, cinnamon roll, and corn bread.

In accordance with the present disclosure bread products can be prepared and produced from compositions and doughs of the present disclosure by any suitable method or process known to those skilled in the art of bread making. By way of example only, breads and other bread products may be produced by steps including mixing, fermenting, modelling, baking and cooling. Those skilled in the art will appreciate that the scope of the present disclosure is not limited by reference to any particular process or method of production.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

The present disclosure will now be described with reference to the following specific examples, which should not be construed as in any way limiting the scope of the invention.

### EXAMPLES

The following examples are illustrative of the invention and should not be construed as limiting in any way the general nature of the disclosure of the description throughout this specification.

### Example 1

### Compositions for Bread Making

Described below are two exemplary compositions (Recipe 1 and Recipe 2) formulated by the present inventors and utilized in making breads in accordance with the present disclosure. For these compositions, the following materials were used:

Pea protein isolate: isolated from yellow pea (Canada) by Jian Yuan Co.

Pea starch: extracted from yellow pea (Canada) by Jian Yuan Co.

Rice flour: from Indica rice (Thailand) using wet milling process, by Jian Yuan Co.

Dried yeast: instant dried yeast produced by Angel Yeast Co. Ltd (China)

Xanthan gum: Xanthan Gum Keltrol F purchased from CP Kelco

HPMC: HPMC Methocel K4 m purchased from Dow Chemical Company

### Example 1A

Recipe 1

| Ingredient | Weight (%) |
|---|---|
| Rice flour | 15 |
| Pea starch | 70 |
| Vegetable Oil | 1 |
| Dried yeast | 1.5 |
| Sugar | 4 |
| Salt | 2 |
| Xanthan Gum | 1.2 |
| HPMC | 1.8 |
| Pea protein | 3.5 |

Water:Dry mix = 1:1

### Example 1B

Recipe 2

| Ingredient | Weight (%) |
|---|---|
| Pea starch | 85 |
| Vegetable Oil | 1 |
| Dried yeast | 1.5 |
| Sugar | 4 |
| Salt | 2 |
| Xanthan Gum | 1.2 |
| HPMC | 1.8 |
| Pea protein | 3.5 |

### Example 2—Breads

Breads were made using recipes 1 and 2 from Example 1, according to the following procedure:

1. Dry mix all the ingredients with the exception of vegetable oil, yeast and sugar.

2. Add the yeast into water (30° C.) and add sugar to activate the yeast.

3. Add the vegetable oil into the dry mix and add the yeast solution.

4. Mix at medium speed for approximately 8 min to form a batter-like dough.

5. Ferment at 30° C., 90 RH% for 20-30 min.

6. Mix (at low speed) for 1 min.

7. Prepare bread mould using the resultant dough.

8. Second stage fermentation for another 50-60 min.

9. Bake the bread in an oven at 230° C. for approximately 35 min.

10. Cool bread to room and remove the bread from the mould.

The appearance of the breads produced are shown in FIG. 1. Cross-sections of the loaves are shown in FIG. 2.

A commonly used parameter used to assess bread texture involves measuring the hardness (or softness) of the bread. The hardness of a bread of the present disclosure, produced in accordance with the above exemplified method, was compared with the hardness of a conventional bread comprising wheat flour (protein content 11.9%). Specifically, after baking the textures (hardness) of 5cm thick slices of each bread was determined using a Texture Analyser (VPCR—Q100120C) at different time intervals. The bread slices were compressed by a 90° cone probe for 25 cm with a compression of 1.00 mm/s. The maximum force was recorded, which indicates the hardness of the bread. Results are shown below in Table 1. It can be seen that the gluten-free bread of the present disclosure is softer than the comparable wheat flour bread. While the hardness of both breads increased with increased storage time, the texture of only the gluten-free bread of the present disclosure retained an acceptable texture (softness) after 3 days.

TABLE 1

| Storage time (h) | 0.5 | 24 | 48 | 72 |
|---|---|---|---|---|
| Hardness (g) of gluten-free bread | 332 | 350 | 386 | 391 |
| containing pea protein and pea starch | | | | |
| Hardness (g) of wheat flour bread | 458 | 530 | 541 | 550 |

1. A composition for producing gluten-free bread products, comprising pea starch and at least about 0.5% by weight pea protein based on the total weight of the composition.

2. A composition according to claim 1, wherein the pea protein comprises one or more of a pea protein isolate, pea protein hydrolysate, pea protein concentrate and coagulated pea protein.

3. A composition according to claim 1, comprising between about 1% and about 5% by weight pea protein based on the total weight of the composition.

4. A composition according to claim 1, comprising about 3.5% by weight pea protein based on the total weight of the composition

5. A composition according to claim 1, comprising at least about 5% by weight pea starch based on the total weight of the composition.

6. A composition according to claim 5, comprising between about 10% and about 90% by weight pea starch based on the total weight of the composition.

7. A composition according to claim 5, comprising about 70% by weight, 75% by weight or about 85% by weight pea starch based on the total weight of the composition.

8. A composition according to claim 1, wherein the composition comprises one or more additional ingredients for making the bread product, selected from water, yeast and a gluten-free flour.

9. A composition according to claim 1, wherein the composition comprises pea protein, pea starch, rice flour, yeast, xanthan gum and water, wherein the pea protein is present at at least about 0.5% by weight based on the total weight of the composition.

10. A composition according to claim 9, wherein the pea starch is present at about 70% by weight based on the total weight of the composition.

11. A composition according to claim 1, wherein the composition comprises pea protein, pea starch, yeast and xanthan gum, wherein the pea protein is present at at least about 0.5% by weight based on the total weight of the composition.

12. A composition according to claim 11, wherein the pea starch is present at about 85% by weight based on the total weight of the composition.

13. A composition according to claim 1, wherein the pea starch is uncooked pea starch.

14. A composition according to claim 1, further comprising vegetable oil, sugar, salt and/or hydroxypropylmethycellulose (HPMC).

15. A composition according to claim 1, wherein the composition is in the form of a wet mixture or premix for producing the bread product.

16. A composition according to claim 1, wherein the composition is in the form of a dry mixture or premix for producing the bread product.

17. A dough comprising a composition according to claim 1.

18. (canceled)

19. A gluten-free bread product produced with a composition according to claim 1.

20. A bread product according to claim 19, wherein the bread product comprises leavened or unleavened bread.
